(19) United States
(12) Patent Application Publication
(10) Pub. No.: US 2015/0334068 A1
(43) Pub. Date: Nov. 19, 2015

(54) MESSAGE PROCESSING METHOD AND APPARATUS

(71) Applicant: TENCENT TECHNOLOGY (SHENZHEN) COMPANY LIMITED, Shenzhen, Guangdong (CN)

(72) Inventor: Li Liu, Shenzhen (CN)

(21) Appl. No.: 14/648,853

(22) PCT Filed: Oct. 8, 2013
(86) PCT No.: PCT/CN2013/084824

§ 371 Date: Jun. 1, 2015

(30) Foreign Application Priority Data
Dec. 10, 2012 (CN) 201210528353.X

(51) Int. Cl. H04L 12/58; G06F 17/30; G06F 3/0482

(52) U.S. Cl. CPC H04L 51/22; G06F 3/0482; G06F 17/30601; G06F 17/30876

(57) ABSTRACT

In an embodiment of the present invention, a timeline list and an unread message list are set in a message server for each user, the timeline list including identifiers of all messages of the user, and the unread message list including identifiers of all unread messages of the user; and the message server adds, when a message publisher publishes a new message, an identifier of the new message separately to a timeline list and an unread message list of a user corresponding to the message publisher, identifiers of messages in the timeline list and identifiers of messages in the unread message list being both ranked in a reverse chronological order of generation times of the messages.

### RELATED APPLICATION

This application claims priority to Chinese Patent Application No. 201210528353.X, entitled “UNREAD MESSAGE PROCESSING METHOD, PRESENTATION METHOD, AND APPARATUS”, and filed with the Chinese Patent Office on Dec. 10, 2012, which is incorporated by reference in its entirety.

### FIELD OF THE TECHNOLOGY

The present disclosure relates to the field of Internet technologies, and in particular, to a message processing method and apparatus.

### BACKGROUND OF THE DISCLOSURE

With the development of Internet technologies, a data amount on the Internet is becoming increasingly larger and a data increasing speed is becoming increasingly faster. When a user views data, it is very necessary for the user to find unread data quickly. For example, a microblog is a typical User Generated Content (UGC) application, in which data expands over time; and by listening to persons that interest a user, the user may browse, on a microblog home page, microblogs published by these users. A method for organizing messages on the microblog home page is implemented by using a timeline, that is, identifiers of generated data of the user are ranked in a reverse chronological order, and each time the user enters the home page, the user can see an identifier of a message closest to a current time.

### SUMMARY

The present disclosure provides a message processing method and apparatus, which can display an unread message of a user visually.

The technical solutions of the present disclosure are implemented in this manner:

An embodiment of the present invention provides a message processing method, a timeline list and an unread message list being set in a message server for each user, the timeline list including identifiers of all messages of the user, and the unread message list including identifiers of all unread messages of the user, the method including:

adding, by the message server when a message publisher publishes a new message, an identifier of the new message separately to a timeline list and an unread message list of a user corresponding to the message publisher, identifiers of messages in the timeline list and identifiers of messages in the unread message list being both ranked in a reverse chronological order of generation times of the messages.

An embodiment of the present invention further provides a message processing method, a timeline list and an unread message list of a user being displayed in a message client, the timeline list including identifiers of all messages of the user, and the unread message list including identifiers of all unread messages of the user, the method including:

displaying, by the message client when a message newly published by a message publisher is received, an identifier of the newly published message in the timeline list and the unread message list separately, identifiers of messages in the timeline list and identifiers of messages in the unread message list being both ranked in a reverse chronological order of generation times of the messages.

An embodiment of the present invention further provides a message processing apparatus, including:

a storage module, configured to store a message;

a timeline list module, configured to set a timeline list for each user, the timeline list including identifiers of all messages of the user; and when a new message is added to the storage module, add an identifier of the message to a timeline list of a user corresponding to a publisher of the message, identifiers of messages in the timeline list being ranked in a reverse chronological order of generation times of the messages; and

an unread message list module, configured to set an unread message list for each user, the unread message list including identifiers of all unread messages of the user; and when a new message is added to the storage module, add an identifier of the message to an unread message list of a user corresponding to a publisher of the message, identifiers of messages in the unread message list being ranked in a reverse chronological order of generation times of the messages.

An embodiment of the present invention further provides a message processing apparatus, including:

a receiving module, configured to receive a message published by a message publisher; and

a presentation module, configured to present a timeline list and an unread message list of a user, the timeline list including identifiers of all messages of the user, and the unread message list including identifiers of all unread messages of the user; and display, separately in the timeline list and the unread message list when the receiving module receives a new message published by the message publisher, an identifier of the message newly published by the message publisher, identifiers of messages in the timeline list and identifiers of messages in the unread message list being both ranked in a reverse chronological order of generation times of the messages.

An embodiment of the present invention further provides a non-volatile computer readable storage medium, including a group of computer instructions for processing an unread message, the computer instructions being executed by one or more processors to complete the following operations:

setting a timeline list and an unread message list, the timeline list including identifiers of all messages of the user, and the unread message list including identifiers of all unread messages of the user; and

adding, when a message publisher publishes a new message, an identifier of the new message separately to a timeline list and an unread message list of a user corresponding to the message publisher, identifiers of messages in the timeline list and identifiers of messages in the unread message list being both ranked in a reverse chronological order of generation times of the messages.

An embodiment of the present invention further provides a non-volatile computer readable storage medium, including a group of computer instructions for processing an unread message, the computer instructions being executed by one or more processors to complete the following operations:

displaying a timeline list and an unread message list of a user, the timeline list including identifiers of all messages of the user, and the unread message list including identifiers of all unread messages of the user;

displaying, when a message newly published by a message publisher is received, an identifier of the newly published message in the timeline list and the unread message list separately, identifiers of messages in the timeline list and identifiers of messages in the unread message list being both ranked in a reverse chronological order of generation times of the messages.

As can be seen, according to the message processing method and apparatus provided by the embodiments of the present invention, when a new message is added, an identifier of the message can be added to an unread message list, thereby displaying an unread message of a user visually.

### BRIEF DESCRIPTION OF THE DRAWINGS

FIG. 1 is a flowchart of a message processing method according to an embodiment of the present invention;

FIG. 2 is a flowchart of a message processing method according to another embodiment of the present invention;

FIG. 3 is a schematic diagram of an unread message list according to an embodiment of the present invention;

FIG. 4 is a schematic structural diagram of a message processing apparatus according to an embodiment of the present invention;

FIG. 5 is a flowchart of a message processing method according to an embodiment of the present invention; and

FIG. 6 is a schematic structural diagram of a message processing apparatus according to an embodiment of the present invention.

### DESCRIPTION OF EMBODIMENTS

The following describes the technical solutions of the present disclosure with reference to the accompanying drawings and embodiments.

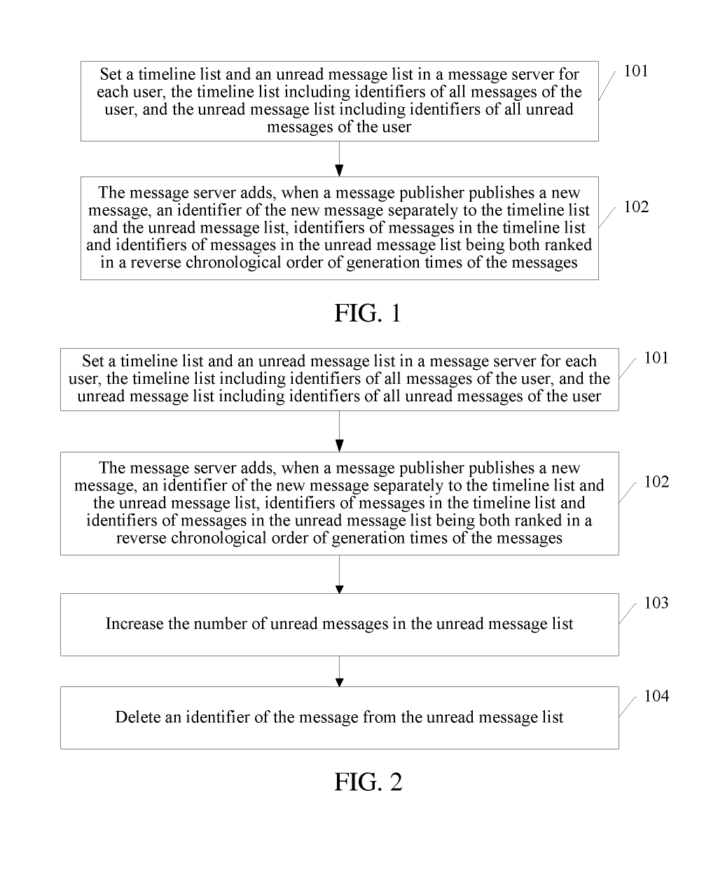

FIG. 1 is a flowchart of a message processing method according to an embodiment of the present invention, including:

Step 101: Set a timeline list and an unread message list in a message server for each user, the timeline list including identifiers of all messages of the user, and the unread message list including identifiers of all unread messages of the user.

Step 102: The message server adds, when a message publisher publishes a new message, an identifier of the new message separately to the timeline list and the unread message list, identifiers of messages in the timeline list and identifiers of messages in the unread message list being both ranked in a reverse chronological order of generation times of the messages.

In the foregoing step 101, after a timeline list and an unread message list for a user are set, when a message publisher corresponding to the user publishes a new message, an identifier of the new message may be directly added to the timeline list and the unread message list of the user, and it is not required to perform an operation, in step 101, of setting a timeline list and an unread message list each time when there is a new message.

In the foregoing method, the unread message list may include multiple sublists. An identifier of a message in the unread message list may be stored, according to a category of the message, in a sublist of the category. The category of the message may be determined according to a message publisher category, a message content category, or a combination of the message publisher category and the message content category.

The number of unread messages may be further recorded in the unread message list. In this case, after the identifier of the new message is added to the timeline list and the unread message list in step 102, the method further includes step 103 of increasing the number of unread messages in the unread message list, as shown in FIG. 2.

If the unread message list includes multiple sublists, the number of unread messages in each sublist may be separately recorded. In this case, step 103 further includes: increasing the number of unread messages in a sublist corresponding to a category of the newly added message.

In addition, after the user reads an unread message in the unread message list, the foregoing method further includes step 104 of deleting an identifier of the message from the unread message list. If the number of unread messages is further recorded in the unread message list, the number of unread messages in the unread message list further needs to be reduced.

If an identifier of a message in the unread message list is stored according to a category of the message, step 104 includes: deleting the identifier of the message from a sublist of a corresponding category according to the category of the message and reducing the number of unread messages in a subcategory.

The following uses a microblog message as an example and describes the present disclosure in detail with reference to a specific embodiment.

In this embodiment, a method for designing a microblog Timeline with an unread message list is used, which is implemented by adding an unread message list and counting unread messages. An identifier of a message in the unread message list may be stored according to a list of the message, and identifiers of messages in different categories are stored in sublists of the categories. A message may be categorized according to a message publisher category, for example, an unread message of a “verified celebrity” or an unread message of a “friend”, may be categorized according to a message content category, for example, an unread message “about food” or an unread message “about news”, or may be categorized according to a combination of the message publisher category and the message content category, for example, an unread message “about food” published by a “verified celebrity” or an unread message “about news” published by a “verified celebrity”. When a user accesses a microblog, the unread message list may specifically display the number of unread messages and the number of unread messages in each of sublists of different categories.

Detailed descriptions are as follows:

When a user that the user listens to publishes a microblog message, an identifier of the microblog message is stored in the unread message list and specifically, may be stored in a corresponding sublist according to a type of the microblog message. Meanwhile, the number of unread messages in the unread message list is increased and the number of unread messages in the sublist is increased. An identifier of a message in the unread message list is also ranked in a reverse chronological order.

The user may directly access the unread message list, and when the message is browsed, the identifier of the message is deleted from the unread message list and the number of unread messages in the unread message list is correspondingly reduced.

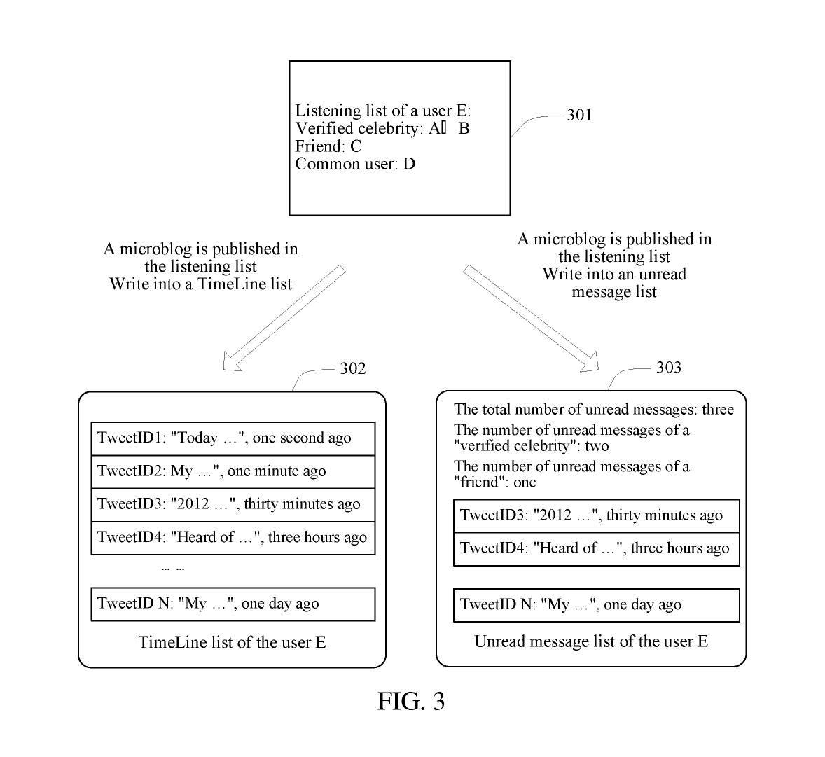

FIG. 3 is a schematic diagram of a design of an unread message list according to an embodiment of the present invention. A user E listens to four users: A, B, C, and D, and as shown in a listening list 301 in FIGS. 3, A and B are verified celebrities, C is a friend of the user, and D is a common user. Identifiers of microblog messages published by these users are added to a Timeline list 302 of the user E in a chronological order, and meanwhile, the identifiers of these messages are also added to an unread message list 303 of the user E.

When the user E browses the Timeline list 302, an identifier of a corresponding microblog message is deleted from the unread message list 303.

The user may also directly access the unread message list 303, and the unread message list 303 prompts that there are two unread messages of a verified celebrity and one unread message of a friend. In this way, the user may directly read a message that interests the user but is missed in the Timeline list 302.

After the user accesses a microblog message, an identifier of the message is deleted from the unread message list 303 and the number of unread messages in the unread message list 303 and the number of unread messages in a sublist in which the message is located are correspondingly reduced.

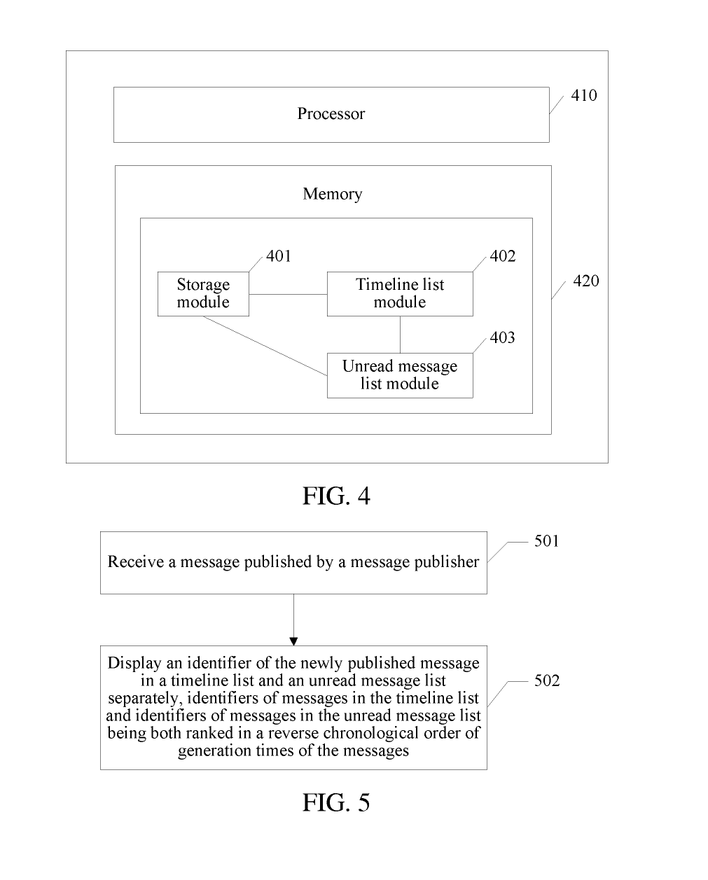

The present disclosure further provides a message processing apparatus. FIG. 4 is a schematic structural diagram of an unread message processing apparatus according to an embodiment of the present invention. The apparatus includes:

one or more processors 410 and a memory 420, the memory 420 including multiple modules that can be executed by the one or more processors 410, and the multiple modules including:
a storage module 401, configured to store a message;
a timeline list module 402, configured to set a timeline list for each user, the timeline list including identifiers of all messages of the user; and when a new message is added to the storage module 401, add an identifier of the message to a timeline list of a user corresponding to a publisher of the message, identifiers of messages in the timeline list being ranked in a reverse chronological order of generation times of the messages; and
an unread message list module 403, configured to set an unread message list for each user, the unread message list including identifiers of all unread messages of the user; and when a new message is added to the storage module 401, add an identifier of the message to an unread message list of a user corresponding to a publisher of the message, identifiers of messages in the unread message list being ranked in a reverse chronological order of generation times of the messages.

In the foregoing apparatus, the unread message list module 403 may store an identifier of a message in the unread message list according to a category of the message, store identifiers of messages in different categories in sublists of the categories, and collect statistics on the number of unread messages in each sublist, where the message is categorized according to a message publisher category, a message content category, or a combination of the message publisher category and the message content category.

When an identifier of a message is added to the unread message list, the unread message list module 403 may add, according to a category of the message, the identifier of the message to a sublist of the corresponding category; and increase the number of unread messages in the sublist.

In the foregoing apparatus, the unread message list module 403 may be further configured to collect statistics on the number of unread messages in the unread message list; and further increase the number of unread messages in the unread message list when an identifier of a message is added to the unread message list.

In the foregoing apparatus, the timeline list module 402 is further configured to receive a message reading request including an identifier of a message, extract the message from the storage module 401 and feed back the message, and send extraction information including the identifier of the message to the unread message list module 403.

The unread message list module 403 is further configured to receive the extraction information including the identifier of the message and delete the identifier of the message from the unread message list.

In the foregoing apparatus, the unread message list module 403 is further configured to receive a message reading request including an identifier of a message, extract the message from the storage module 401 and feed back the message, and delete the identifier of the message from the unread message list, and reduce the number of unread messages in the unread message list; and delete an identifier of a message from a sublist of a corresponding category according to a category of the message and reduce the number of unread messages in a subcategory if the identifier of the message in the unread message list is stored according to the category of the message.

The present disclosure further provides a message processing method of a message client as shown in FIG. 5. A timeline list and an unread message list of a user are displayed in a message client. The timeline list includes identifiers of all messages of the user, and the unread message list includes identifiers of all unread messages of the user. The method includes:

Step 501: Receive a message published by a message publisher.

Step 502: Display an identifier of the newly published message in the timeline list and the unread message list separately, identifiers of messages in the timeline list and identifiers of messages in the unread message list being both ranked in a reverse chronological order of generation times of the messages.

In step 502, the identifier of the new message may be separately displayed in the unread message list according to a category of the message, and identifiers of messages in different categories are displayed in sublists of the categories, where the message is categorized according to a message publisher category, a message content category, or a combination of the message publisher category and the message content category.

In addition, the number of unread messages in each sublist may be further displayed.

After the user reads an unread message in the unread message list, the foregoing method further includes: deleting an identifier of the message from the unread message list. If the number of unread messages is further recorded in the unread message list, the number of unread messages in the unread message list further needs to be reduced.

If an identifier of a message in the unread message list is stored according to a category of the message, the identifier of the message is deleted from a sublist of a corresponding category according to the category of the message and the number of unread messages in a subcategory is reduced.

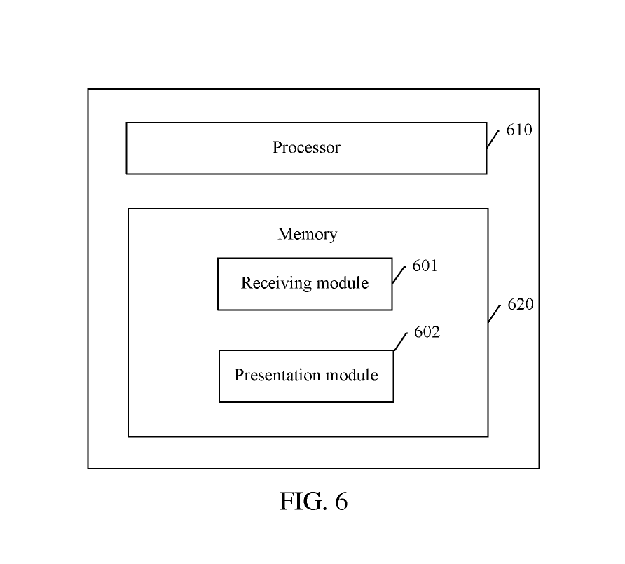

The present disclosure further provides a message processing apparatus, as shown in FIG. 6, including:

one or more processors 610 and a memory 620, the memory 620 including one or more modules that can be executed by the one or more processors 610, and the one or more modules including:

a receiving module 601, configured to receive a message published by a message publisher; and

a presentation module 602, configured to present a timeline list and an unread message list of a user, the timeline list including identifiers of all messages of the user, and the unread message list including identifiers of all unread messages of the user;

and display, separately in the timeline list and the unread message list when the receiving module 601 receives a new message published by the message publisher, an identifier of the message newly published by the message publisher, identifiers of messages in the timeline list and identifiers of messages in the unread message list being both ranked in a reverse chronological order of generation times of the messages.

In the foregoing processing apparatus, the presentation module 602 may separately display the identifier of the newly added message in the unread message list according to a category of the message, display identifiers of messages in different categories in sublists of the categories, and further display the number of unread messages in each sublist.

The message is categorized according to a message publisher category, a message content category, or a combination of the message publisher category and the message content category.

After the user reads an unread message in the unread message list, the foregoing presentation module 602 deletes an identifier of the message from the unread message list. If the number of unread messages is further recorded in the unread message list, the number of unread messages in the unread message list further needs to be reduced.

If an identifier of a message in the unread message list is stored according to a category of the message, the identifier of the message is deleted from a sublist of a corresponding category according to the category of the message and the number of unread messages in a subcategory is reduced.

In conclusion, according to the message processing method and apparatus provided by the present disclosure, by setting and maintaining an unread message list, an unread message of a user can be displayed visually and unread messages can be separately displayed according to different categories. Especially, for a microblog message, because of a characteristic that a time when a user accesses a microblog is fragmental, the unread message list can avoid the case of message losing effectively, avoid repeating pulling and reading duplicate content, and avoid a traffic waste caused by repeating refreshing a Timeline. By categorizing an unread message according to a preference of a user, the user can be effectively guided to read more content.

A person of ordinary skill in the art may understand that all or some of the steps of the foregoing embodiments may be implemented by using hardware, or may be implemented by a program instructing relevant hardware. The program may be stored in a computer readable storage medium. The storage medium may be a read-only memory, a magnetic disk, or an optical disc, or the like.

The foregoing descriptions are merely preferred embodiments of the present invention, but are not intended to limit the present disclosure. Any modification, equivalent replacement, or improvement made within the spirit and principle of the present disclosure shall fall within the protection scope of the present disclosure.

1. A message processing method, a timeline list and an unread message list being set in a message server for each user, the timeline list comprising identifiers of all messages of the user, and the unread message list comprising identifiers of all unread messages of the user, the method comprising:
adding, by the message server when a message publisher publishes a new message, an identifier of the new message separately to a timeline list and an unread message list of a user corresponding to the message publisher, identifiers of messages in the timeline list and identifiers of messages in the unread message list being both ranked in a reverse chronological order of generation times of the messages; wherein
an identifier of a message in the unread message list is stored according to a category of the message, and identifiers of messages in different categories are stored in sublists of the categories, wherein the message is categorized according to a message publisher category, a message content category, or a combination of the message publisher category and the message content category; and
the adding, by the message server, an identifier of the new message to an unread message list of a user corresponding to the message publisher comprises:
adding, according to a category of the message, the identifier of the message to a sublist of the corresponding category.

2. (canceled)

3. The method according to claim 1, further comprising:
collecting statistics on the number of unread messages in each sublist; and
increasing, when the identifier of the new message is added to a sublist of a corresponding list in the unread message list, the number of unread messages in the sublist.

4. The method according to claim 1, wherein the method further comprises: collecting statistics on the number of unread messages in the unread message list; and
further increasing the number of unread messages in the unread message list when the identifier of the new message is added to the unread message list.

5. The method according to claim 4, wherein the method further comprises:
deleting an identifier of a message from the unread message list and reducing the number of unread messages in the unread message list when the message is read from the unread message list; and deleting an identifier of a message from a sublist of a corresponding category according to a category of the message and reducing the number of unread messages in a subcategory if the identifier of the message in the unread message list is stored according to the category of the message.

6. The method according to claim 1, wherein the method further comprises:
deleting an identifier of a message from the unread message list when the message is read from the timeline list.

7. A message processing method, a timeline list and an unread message list of a user being displayed in a message client, the timeline list comprising identifiers of all messages of the user, and the unread message list comprising identifiers of all unread messages of the user, the method comprising:
displaying, by the message client when a message newly published by a message publisher is received, an identifier of the newly published message in the timeline list and the unread message list separately, identifiers of messages in the timeline list and identifiers of messages in the unread message list being both ranked in a reverse chronological order of generation times of the messages;
wherein the identifier of the new message is separately displayed in the unread message list according to a category of the message, and identifiers of messages in different categories are displayed in sublists of the categories, wherein
the message is categorized according to a message publisher category, a message content category, or a combination of the message publisher category and the message content category.

8. (canceled)

9. The method according to claim 7, further comprising:
collecting statistics on the number of unread messages in each sublist; and
increasing, when the identifier of the new message is displayed in a sublist of a corresponding list in the unread message list, the number of unread messages in the sublist.

10. The method according to claim 7, wherein the method further comprises: collecting statistics on the number of unread messages in the unread message list; and
further increasing the number of unread messages in the unread message list when an identifier of a message is added to the unread message list.

11. The method according to claim 10, wherein the method further comprises:
deleting an identifier of a message from the unread message list and reducing the number of unread messages in the unread message list when the message is read from the unread message list; and deleting an identifier of a message from a sublist of a corresponding category according to a category of the message and reducing the number of unread messages in a subcategory if the identifier of the message in the unread message list is stored according to the category of the message.

12. The method according to claim 7, wherein the method further comprises:
deleting an identifier of a message from the unread message list when the message is read from the timeline list.

13. A message processing apparatus, comprising:
one or more processors and a memory, the memory comprising multiple modules that can be executed by the one or more processors, and the multiple modules comprising:
a storage module, configured to store a message;
a timeline list module, configured to set a timeline list for each user, the timeline list comprising identifiers of all messages of the user; and when a new message is added to the storage module, add an identifier of the message to a timeline list of a user corresponding to a publisher of the message, identifiers of messages in the timeline list being ranked in a reverse chronological order of generation times of the messages; and
an unread message list module, configured to set an unread message list for each user, the unread message list comprising identifiers of all unread messages of the user; and when a new message is added to the storage module, add an identifier of the message to an unread message list of a user corresponding to a publisher of the message, identifiers of messages in the unread message list being ranked in a reverse chronological order of generation times of the messages;
wherein the unread message list module stores an identifier of a message l the unread message list according to a category of the message, and stores identifiers of messages in different sublists of the categories, wherein the message is categorized according to a message publisher category, a message content category, or a combination of the message publisher category and the message content category; and
the unread message list modules adds, according to a category of message, an identifier of the message to a sublist of the corresponding category when the identifier of the message is added to the unread message list.

14. (canceled)

15. The apparatus according to claim 13, wherein the unread message list module is further configured to collect statistics on the number of unread messages in each sublist; and increase, when an identifier of a message is added to a corresponding sublist of the unread message list, the number of unread messages in the sublist.

16. The apparatus according to claim 13, wherein the unread message list module is further configured to collect statistics on the number of unread messages in the unread message list; and further increase the number of unread messages in the unread message list when an identifier of a message is added to the unread message list.

17. The apparatus according to claim 16, wherein the unread message list module is further configured to receive a message reading request comprising an identifier of a message, extract the message from the storage module, and delete the identifier of the message from the unread message list, and reduce the number of unread messages in the unread message list; and delete an identifier of a message from a sublist of a corresponding category according to a category of the message and reduce the number of unread messages in a subcategory if the identifier of the message in the unread message list is stored according to the category of the message.

18. The apparatus according to claim 13, wherein
the timeline list module is further configured to receive a message reading request comprising an identifier of a message, extract the message from the storage module, and send extraction information comprising the identifier of the message to the unread message list module; and
the unread message list module is further configured to receive the extraction information comprising the identifier of the message and delete the identifier of the message from the unread message list.

19. A message processing apparatus, comprising:
one or more processors and a memory, the memory comprising one or more modules that can be executed by the one or more processors, and the one or more modules comprising:
a receiving module, configured to receive a message published by a message publisher; and
a presentation module, configured to present a timeline list and an unread message list of a user, the timeline list comprising identifiers of all messages of the user, and the unread message list comprising identifiers of all unread messages of the user; and display, separately in the timeline list and the unread message list when the receiving module receives a new message published by the message publisher, an identifier of the message newly published by the message publisher, identifiers of messages in the timeline list and identifiers of messages in the unread message list being both ranked in a reverse chronological order of generation times of the messages;
wherein the presentation module separately displays the identifier of the new message in the unread message list according to a category of the message and display identifiers of messages in different categories in sublists of the categories, wherein
the message is categorized according to a message publisher category, a message content category, or a combination of the message publisher category and the message content category.

20. (canceled)

21. A non-volatile computer readable storage medium, comprising a group of computer instructions for processing an unread message, the computer instructions being executed by one or more processors to complete the following operations:
setting a timeline list and an unread message list, the timeline list comprising identifiers of all messages of the user, and the unread message list comprising identifiers of all unread messages of the user; and
adding, when a message publisher publishes a new message, an identifier of the new message separately to a timeline list and an unread message list of a user corresponding to the message publisher, identifiers of messages in the timeline list and identifiers of messages in the unread message list being both ranked in a reverse chronological order of generation times of the messages;
wherein
an identifier of a message in the unread message list is stored according to a category of the message, and identifiers of messages in different categories are stored in sublists of the categories, wherein the message is categorized according to a message publisher category, a message content category, or a combination of the message publisher category and the message content category; and
the adding, by the message server, an identifier of the new message to an unread message list of a user corresponding to the message publisher comprises:
adding, according to a category of the message, the identifier of the message to a sublist of the corresponding category.

22. A non-volatile computer readable storage medium, comprising a group of computer instructions for processing an unread message, the computer instructions being executed by one or more processors to complete the following operations:
displaying a timeline list and an unread message list of a user, the timeline list comprising identifiers of all messages of the user, and the unread message list comprising identifiers of all unread messages of the user;
displaying, when a message newly published by a message publisher is received, an identifier of the newly published message in the timeline list and the unread message list separately, identifiers of messages in the timeline list and identifiers of messages in the unread message list being both ranked in a reverse chronological order of generation times of the messages;
wherein the identifier of the new message is separately displayed in the unread message list according to a category of the message, and identifiers of messages in different categories are displayed in sublists of the categories, wherein
the message is categorized according to a message publisher category, a message content category, or a combination of the message publisher category and the message content category.
